(19) United States
(12) Patent Application Publication
(10) Pub. No.: US 2016/0183279 A1
(43) Pub. Date: Jun. 23, 2016

(54) Time Division Multiplex System and Transmission Method Thereof

(71) Applicant: MEDIATEK INC., Hsin-Chu (TW)

(72) Inventors: Li-Chun Ko, Taipei City (TW); Chia-Hsiang Hsu, Kaohsiung City (TW); Hao-Hua Kang, Taoyuan City (TW)

(21) Appl. No.: 14/955,059

(22) Filed: Dec. 1, 2015

Related U.S. Application Data
(60) Provisional application No. 62/094,082, filed on Dec. 19, 2014.

(51) Int. Cl. H04W 72/12; H04W 72/04

(52) U.S. Cl. CPC H04W 72/1205; H04W 72/0446

(57) ABSTRACT

A time division multiplex system has a client communications device and an external communications device. The client communications device has a first radio activity schedule. The external communications device has a second radio activity schedule. When the client communications device detects the second radio activity schedule, the client communications device reschedules the first radio activity schedule according to the second radio activity schedule.

### CROSS REFERENCE TO RELATED APPLICATIONS

This application claims the benefit of U.S. provisional application No. 62/094,082, filed Dec. 19, 2014.

### BACKGROUND

Wireless communication has been an important and essential data transmission technique in recent years since it takes several advantages such as high transmission flexibility, high transmission convenience, and high transmission quality. Nowadays, several wireless communications modules for transmitting various radio signals are integrated into a portable electronic device. For example, a blue-tooth (BT) module, a Wi-Fi module, and a long-term-evolution (LTE) module are integrated in a smartphone. To improve the transmission efficiency, two transmission types are applied to achieve the coexistence of multi-radios transmission. The first transmission type is frequency division Multiplex (FDM). The second transmission type is time division Multiplex (TDM). The key idea of the transmission using FDM is to partition a wireless frequency spectrum into several frequency bands and further allocate each radio signal to the corresponding frequency band. The key idea of the transmission using TDM is to determine several time slots during a transmission time interval and then allocate each radio signal to the corresponding time slot. Both FDM and TDM can provide multi-radios coexistence transmission.

However, in FDM transmission, the transmission performance may be sacrificed since the filter used in FDM circuit reduces the signal dynamic range of transmission. Further, FDM circuit requires larger layout size than TDM circuit. Thus, TDM takes more attention for applying to a small and precision electronic device.

In TDM transmission, since each radio signal is allocated to different time slot, only one radio signal is activated at a time instant. When two radio signals are accessed in the same time (i.e., two radio signals are allocated to the same slot) by external command, error, or time slot shifting, the inter-radio interference is introduced, leading to performance degradation and information loss of the transmission. To avoid inter-radio interference, several transmission protection methods are applied with sacrificing channel utility rate. Thus, to develop a TDM transmission method in avoidance of inter-radio interference with high channel utility rate is an important issue.

### SUMMARY

In an embodiment of the present invention, a transmission method for a time division multiplex system is disclosed. The time division multiplex system includes a client communications device and an external communications device. The method includes providing a first radio activity schedule for the first communications device, and providing a second radio activity schedule for the second communications device. When the first communications device detects the second radio activity schedule from the second communications device, the first communications device reschedules the first radio activity schedule according to the second radio activity schedule.

In another embodiment of the present invention, a time division multiplexing system includes a first communications device having a first radio activity schedule, and a second communications device having a second radio activity schedule. When the first communications device detects the second radio activity schedule from the second communications device, the first communications device reschedules the first radio activity schedule according to the second radio activity schedule.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic structure of a time division multiplex system according to an embodiment of the present invention.

FIG. 2 shows a timing diagram for the time division multiplex system in FIG. 1.

### DETAILED DESCRIPTION

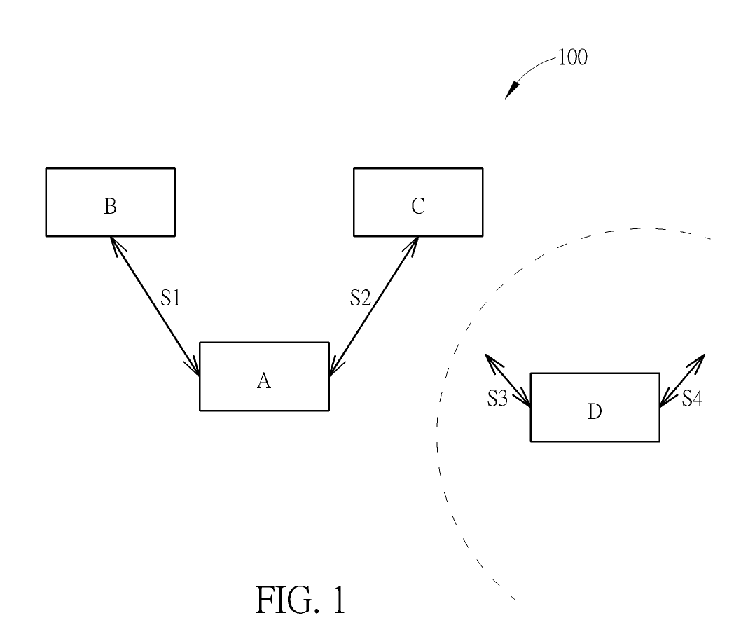

FIG. 1 is a schematic structure of a time division multiplex system 100 according to an embodiment of the present invention. As shown in FIG. 1, the time division multiplex system 100 includes a communications device A, a communications device B, a communications device C, and a communications device D. Radio signals S1, radio signals S2, radio signals S3, and radio signals S4 are considered in this embodiment. Specifically, radio signals S1 and radio signals S2 can be heterogeneous radio signals. For example, radio signals S1 can be 802.11 (Wi-Fi) signals and radio signals S2 can be 802.15.1 (Bluetooth) signals. However radio signals S1 and radio signals S2 can also be homogeneous radio signals. For example, both radio signals S1 and radio signals S2 can be 802.11 (Wi-Fi) signals or 802.15.1 (Bluetooth) signals, but is not limited thereto. In another embodiment, radio signals S1 and radio signals S2 can be any heterogeneous or homogeneous radio signals. The communication device A and B use radio signal S1 to communicate. The communication device A and C use radio signal S2 to communicate. The communications device D has the similar functions to the communications device A, having the capability of communicating with other devices using radio signal S3 and S4. In addition, at least one of radio signal S3 or S4 is the same as radio signals S1 or S2. In this embodiment, radio signals S3 has the same signal format as radio signals S1. The communications device A to communications device D can be considered as any type of communications device. For example, the communications device A can be a wireless local area network hotspot (WEAN hotspot). The communications device D can be a wireless local area network client (WLAN client). In time division multiplex transmission, only one of radio signals S1 and S2 can be communicated to the first communications device A at one time (i.e., either using radio signals S1 to communicate with device B or using radio signals S2 to communicate device C at one time). Similarly, only one of radio signals S3 and S4 can be communicated to the communications device D at one time (i.e., communicating radio signals S3 or communicating radio signals S4). To avoid inter-radio interference, the first communications device A broadcasts a clear to send (CTS) signal to pause all nearby radio activity using the same type of radio signals before the communications device A using radio signals S2 to communicate with device C. When the CTS signal is received by the communications device B, the communication of radio signals S1 from the communications device B is disabled during a time interval. The time interval is more than or equal to the time length allocated for radio signals S2. Thus, the communications device A can communicate with device C using radio signals S2 during a time interval without experiencing any inter-radio interference caused by radio signals S1.

However, when the communications device D is activated in time division multiplex system 100 and broadcasts an external CTS (ECTS) signal (i.e., the ECTS signal is defined as the CTS signal broadcasting from the communications device D in order to avoid inter-radio interference) , the communications device B receives the ECTS signal from the communications device D so that the communication of radio signals S1 from the communications device B is disabled during the time interval triggered by the ECTS signal. Since the communication of radio signals S1 is disabled during the time intervals triggered by both CTS signal and ECTS signal, when the CTS signal and ECTS signal are staggered in time (or interleaved in time), the communication time for radio signals S1 is reduced, thus degrading the transmission efficiency. To avoid the reduction of transmission efficiency, a transmission method with respect to an adaptive radio activity schedule is introduced in the embodiment. The detail expressions and illustrations of the transmission method are written below.

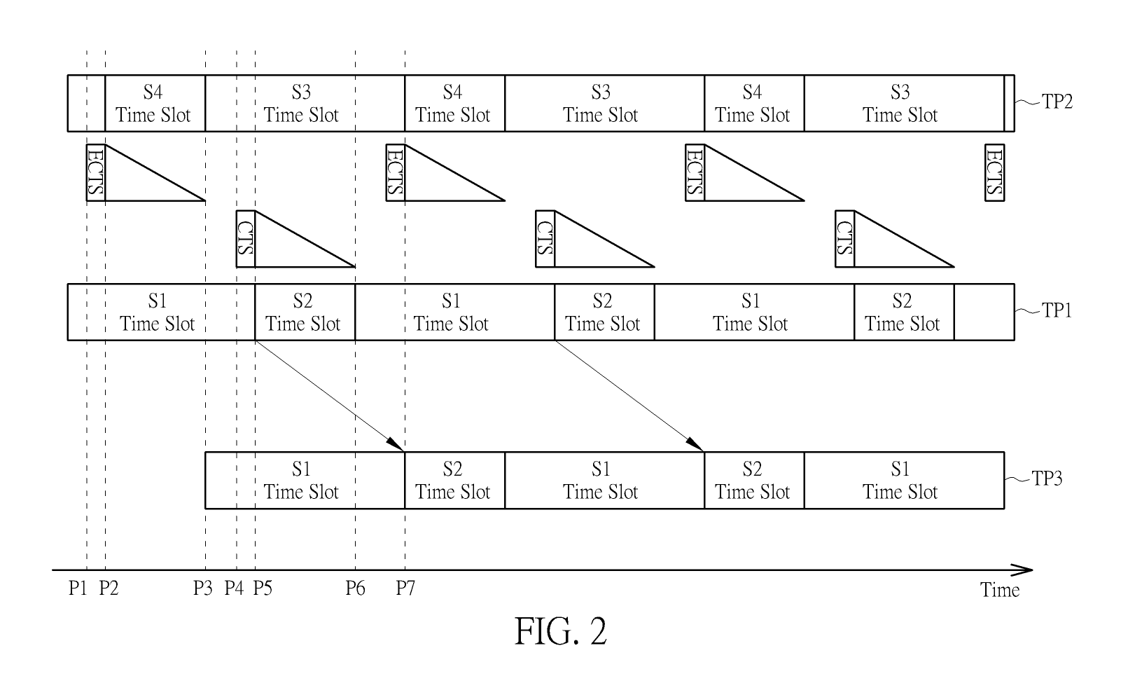

FIG. 2 shows a timing diagram for the time division multiplex system 100. As shown in FIG. 2, a radio activity schedule TP1 for the communications device A is predetermined and the information of the radio activity schedule TP1 is stored in the communications device A. The radio activity schedule TP1 includes several time slots allocated to radio signals S1 and radio signals S2. By default, the schedule for using radio signals S1 and radio signals S2 is presented to the radio activity schedule TP1. The length of each time slot of radio signals S1 denotes the length of each period for communicating radio signals S1. The length of each time slot of radio signals S2 denotes the length of each period for communicating radio signals S2. The length of each period for radio signals S1 and a length of each period for radio signals S2 are fixed or variable. To avoid inter-radio interference, the communications device A broadcasts a CTS signal before the communications device A communicates with device C using radio signals S2. The time interval triggered by the CTS signal is more than or equal to the time length allocated for radio signals S2. The time slots of radio signals S1 and radio signals S2 are interleaved to implement time division multiplex transmission.

In FIG. 2, a radio activity schedule TP2 is introduced to associate with communications device D. As indicated in FIG. 2, the radio activity schedule TP2 includes several time slots allocated to radio signals S3 and radio signals S4. The schedule for radio signals S3 and radio signals S4 is presented to the radio activity schedule TP2. The length of each time slot of radio signals S3 denotes the length of each period for communicating radio signals S3. The length of each time slot of radio signals S4 denotes the length of each period for communicating radio signals S4. The length of each period for radio signals S3 and a length of each period for radio signals S4 are fixed or variable. To avoid inter-radio interference, the communications device D broadcasts an ECTS signal before the communications device D communicates with other devices using radio signals S4. The time length triggered by the ECTS signal is more than or equal to the time length allocated for radio signals S4. The time slots of radio signals S3 and radio signals S4 are interleaved to implement time division multiplex transmission.

As shown in FIG. 2, the first time slot allocated for radio signals S2 is allocated to the radio activity schedule TP1 from time P5 to time P6. Since the time length triggered by the CTS signal is more than or equal to the time length of radio signals S2, the first CTS signal is used to avoid inter-radio interference from time P4 to time P6. Similarly, the first time slot for radio signals S4 is allocated to the radio activity schedule TP2 from time P2 to time P3. Since the time length triggered by the ECTS signal is more than or equal to the time length allocated for radio signals S4, the first ECTS signal is used to avoid inter-radio interference from time P1 to time P3. Apparently, because the time interval from time P4 to time P6 and time P1 to time P3 are staggered in time, when the communications device B receives the ECS signal and then receives the ECTS signal, the communications device B can only communicate with device A using radio signals S1 during a shorter time interval. For example, consider the time interval from time P1 to time P6. The communications device B is disabled to use radio signals S1 from time P4 to time P6 according to CTS signal and is disabled to use radio signals S1 from time P1 to time P3 according to ECTS signal. Equivalently, the communications device B can use radio signals S1 during the time interval from time P3 to time P4 and thus suffers from severe transmission efficiency degradation. To solve this problem, when the communications device A detects the radio activity schedule TP2 from the communications device D, the radio activity schedule TP1 is adaptively rescheduled according to the radio activity schedule TP2 in the embodiment. Here, the method for rescheduling the radio activity schedule TP1 is to match the periods for radio signals S2 for the radio activity schedule TP1 to the periods for radio signals S4 for the radio activity schedule TP2. For example, the first time slot for radio signals S2 at time P5 in the radio activity schedule TP1 is aligned to the second time slot for radio signals S4 at time P7 in the radio activity schedule TP2. The subsequent time slots of radio signals S2 in the radio activity schedule TP1 are matched to the subsequent time slots of radio signals S4 in the radio activity schedule TP2 by similar method. After rescheduling, the radio activity schedule TP1 can be presented as the radio activity schedule TP3 in FIG. 2. Specifically, since the time slots of radio signals S2 for the radio activity schedule TP1 and the time slots of radio signals S4 for the radio activity schedule TP2 are periodic, the step for matching the subsequent time slots are omitted.

After rescheduling, the communications device A uses radio signals S1 and radio signals S2 according to the radio activity schedule TP3. The time of CTS signal broadcasted from the communications device A is exactly applied at the time of the ECTS signal broadcasted from the communications device D. By doing so, the CTS signal and the ECTS signal have the same (or almost the same) time intervals to avoid inter-radio interference. Since the time intervals for the CTS signal and the ECTS signal are overlapped, radio signals S1 can be used from the communications device B from time P4 to time P6. As a result, the transmission efficiency (channel utility rate) can be improved.

In the present invention, a time division multiplex system and a transmission method for the time division multiplex system are disclosed. The idea is to rescheduling the radio activity schedule for the communications device to match the radio activity schedule for another communications device. After rescheduling, the time periods for communicating radio signals in communications device and another communications device are overlapped (or almost overlapped). By using the transmission method of the invention, the time division multiplex system can perform no inter-radio interference transmissions without suffering from severe transmission efficiency (channel utility rate) degradation.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A transmission method for a time division multiplex system, the time division multiplex system comprising a first communications device and a second communications device, the method comprising:
providing a first radioactivity schedule for the first communications device;
providing a second radio activity schedule for the second communications device; and
when the first communications device detects the second radio activity schedule from the second communications device, the first communications device rescheduling the first radio activity schedule according to the second radio activity schedule.

2. The method of claim 1, wherein the first radio activity schedule for the first communications device comprises periods for communicating first radio signals and periods for communicating second radio signals.

3. The method of claim 2, wherein the second radio activity schedule for the second communications device comprises periods for communicating third radio signals and periods for communicating fourth radio signals.

4. The method of claim 3, wherein the first communications device rescheduling the first radioactivity schedule according to the second radio activity schedule is matching the periods for communicating the second radio signals in the first radio activity schedule to the periods for communicating the fourth radio signals in the second radio activity schedule.

5. The method of claim 2, wherein the first radio signals and the second radio signals are homogeneous radio signals.

6. The method of claim 2, wherein the first radio signals and the second radio signals are heterogeneous radio signals.

7. The method of claim 2, wherein a length of each period for communicating the first radio signals and a length of each period for communicating the second radio signals are variable.

8. The method of claim 2, wherein a length of each period for communicating the first radio signals and a length of each period for communicating the second radio signals are fixed.

9. The method of claim 2, wherein one of a length of each period for communicating the first radio signals and a length of each period for communicating the second radio signals is variable, and another one of the length of each period for communicating the first radio signals and the length of each period for communicating the second radio signals is fixed.

10. A time division multiplex system comprising:
a first communications device having a first radioactivity schedule; and
an second communications device having a second radio activity schedule;
wherein when the first communications device detects the second radio activity schedule from the second communications device, the first communications device reschedules the first radio activity schedule according to the second radio activity schedule.

11. The system of claim 10, wherein the first radio activity schedule comprises periods for communicating first radio signals and periods for communicating second radio signals.

12. The system of claim 11, wherein the second radio activity schedule comprises periods for communicating third radio signals and periods for communicating fourth radio signals.

13. The system of claim 12, wherein the first communications device matches the periods for communicating the second radio signals in the first radio activity schedule to the periods for communicating the fourth radio signals in the second radio activity schedule.

14. The system of claim 11, wherein the first radio signals and the second radio signals are homogeneous radio signals.

15. The system of claim 11, wherein the first radio signals and the second radio signals are heterogeneous radio signals.

16. The system of claim 11, wherein a length of each period for communicating the first radio signals and a length of each period for communicating the second radio signals are variable.

17. The system of claim 11, wherein a length of each period for communicating the first radio signals and a length of each period for communicating the second radio signals are fixed.

18. The system of claim 11, wherein one of a length of each period for communicating the first radio signals and a length of each period for communicating the second radio signals is variable, and another one of the length of each period for communicating the first radio signals and the length of each period for communicating the second radio signals is fixed.
